(19) United States
(12) Patent Application Publication
(10) Pub. No.: US 2026/0245192 A1
(43) Pub. Date: Aug. 20, 2026

(54) GENERATIVE SAMPLING FOR UNBALANCED OF CLASSES IN IMAGES AND VIDEOS DATASET

(71) Applicant: HITACHI VANTARA LLC, Santa Clara, CA (US)

(72) Inventors: Mauro Arduino DAMO, Windermere, FL (US); Wei LIN, Plainsboro, NJ (US)

(21) Appl. No.: 19/153,909

(22) PCT Filed: Feb. 13, 2023
(86) PCT No.: PCT/US2023/012956

§ 371 Date: Aug. 5, 2025

(51) Int. Cl. G06T 7/00; G06N 20/00; G06V 10/764; G06V 10/774; G06V 10/82

(52) U.S. Cl. CPC G06T 7/0004; G06N 20/00; G06V 10/764; G06V 10/774; G06V 10/82; G06T 2207/10016; G06T 2207/20081; G06T 2207/20084; G06T 2207/30108

(57) ABSTRACT

In example implementations described herein, there are systems and methods for training a machine-trained model for industrial failure detection based on an initial set of training data comprising a plurality of input-output data sets each comprising input data and output data regarding at least one classification of the input data. The method may include identifying at least one classification of the input data, in a plurality of classifications that is under-represented. The method may also include automatically generating, for inclusion in a modified set of training data, additional input-output data sets for the identified at least, one classification to balance a representation of the classifications in the modified set of training data. Finally, the method may include training the machine-trained model based on the modified set of training data comprising at least a subset of the initial set of training data and the additional input-output data sets.

### BACKGROUND

### Field

The present disclosure is generally directed to generating datasets for failure detection associated with industrial processes.

### Related Art

The present disclosure describes a solution to a problem associated with monitoring for industrial defects. The industrial defect monitoring, in some aspects, may be data-driven, however, industrial defects may be rare events. The scarcity of data, in some aspects, may make industrial models (e.g., artificial intelligence and/or machine learning (AI/ML) models) difficult to develop and/or may limit the number of models that may be used for defect monitoring in association with one or more industrial processes. In some aspects, the rarity of industrial defects may also make it more challenging to improve model accuracy.

The rarity of industrial defects and/or failure events, in some aspects, may be because of the high quality of standards for industrial components. Accordingly, failure events may be difficult to capture in association with an industrial process which may present challenges to capturing a sufficient number of data points (e.g., images, audio, video, or other data) to train an accurate model (e.g., a machine-trained model such as an AI/ML model) for defect and/or failure event detection. Additionally, the cost of capturing, managing, and annotating data sets (e.g., images, audio, video, or other data) may be too high for smaller companies and, in many instances, data sets may not be shared between companies to reduce and/or share the costs associated with the data management or to improve the quality of the data available to each company. Because of the difficulty in developing a machine-trained model, it is not unusual to involve a subject matter expert, like an engineer, in an advisory role to identify industrial defects and/or failure events in data (e.g., images or other data).

### SUMMARY

Example implementations described herein involve an innovative method for increasing the volume of training data for a machine-trained model associated with industrial applications using synthetic data, increasing the machine-trained model performance, and/or reducing the machine-trained model errors. The disclosed method, in some aspects, may help a company/user that suffers from a lack of data for model training. In some aspects, the method provides a solution to the problems associated with the rarity of industrial defects and/or failure events and/or the high cost of collecting and maintaining a sufficient volume of defect and/or failure event data for training accurate one or more machine-trained models.

For example, the method, by increasing the volume of training data for industrial applications using synthetic data, may significantly reduce the need for raw data and the associated costs of collecting the raw data. Additionally, a high cost of annotation and data management of images (or other data) for AI/ML projects (e.g., for training a machine-trained model) may be significantly reduced by automatically annotating the images (or other data) using a transfer learning technique or subject matter expert advisory. Accordingly, increasing the volume of training data for industrial applications using synthetic data may improve the statistical confidence of the model and the generalization power (e.g., may improve model performance). In some aspects, new data may be used to teach the model new patterns, further increasing the machine-trained model performance and reducing the machine-trained model errors.

Aspects of the present disclosure include a method, non-transitory computer readable medium storing instructions for execution by a processor, system, or apparatus for training a machine-trained model for industrial failure detection based on an initial set of training data. The initial set of training data, in some aspects, may include a plurality of input-output data sets each including input data regarding an industrial object and output data regarding at least one classification of the input data. The method may include identifying, in the initial set of training data, at least one classification of the input data in a plurality of classifications of the input data that is under-represented. The method may further include automatically generating, for inclusion with the initial set of training data in a modified set of training data, additional input-output data sets for the identified at least one classification to balance a representation of the classifications of the plurality of classifications in the modified set of training data and training the machine-trained model based on the modified set of training data including at least a subset of the initial set of training data and the additional input-output data sets.

Aspects of the present disclosure include the non-transitory computer readable medium storing instructions for execution by a processor, which can involve instructions for identifying, in the initial set of training data, at least one classification of the input data in a plurality of classifications of the input data that is under-represented. The instructions may further include instructions for automatically generating, for inclusion with the initial set of training data in a modified set of training data, additional input-output data sets for the identified at least one classification to balance a representation of the classifications of the plurality of classifications in the modified set of training data and training the machine-trained model based on the modified set of training data including at least a subset of the initial set of training data and the additional input-output data sets.

Aspects of the present disclosure include the system, which can involve means for identifying, in the initial set of training data, at least one classification of the input data in a plurality of classifications of the input data that is under-represented. The means may further include means for automatically generating, for inclusion with the initial set of training data in a modified set of training data, additional input-output data sets for the identified at least one classification to balance a representation of the classifications of the plurality of classifications in the modified set of training data and training the machine-trained model based on the modified set of training data including at least a subset of the initial set of training data and the additional input-output data sets.

Aspects of the present disclosure include the apparatus, which can involve a processor, configured to identify, in the initial set of training data, at least one classification of the input data in a plurality of classifications of the input data that is under-represented. The processor may further be configured to automatically generate, for inclusion with the initial set of training data in a modified set of training data, additional input-output data sets for the identified at least one classification to balance a representation of the classifications of the plurality of classifications in the modified set of training data and train the machine-trained model based on the modified set of training data including at least a subset of the initial set of training data and the additional input-output data sets.

### BRIEF DESCRIPTION OF DRAWINGS

FIG. 1 is a diagram illustrating a set of functional components of a system in accordance with some aspects of the disclosure.

FIG. 2 is a diagram illustrating some aspects of the data management component and auto-labeling/annotation component in accordance with some aspect of the disclosure.

FIG. 3 is a diagram illustrating a set of operations associated with the in accordance with some aspects of the disclosure.

FIG. 4 is a diagram illustrating a set of operations associated with the data analysis component in accordance with some aspects of the disclosure.

FIG. 5 is a diagram illustrating a set of operations associated with the image generation component in accordance with some aspects of the disclosure.

FIG. 6 is a diagram illustrating a set of operations associated with the generative model training component and tensor framework image generation component in accordance with some aspects of the disclosure.

FIG. 7 is a diagram illustrating elements of a morphism in accordance with some aspects of the disclosure.

FIG. 8 is a diagram illustrating a generative adversarial network (GAN) in accordance with some aspects of the disclosure.

FIG. 9 is a diagram illustrating a variational autoencoder in accordance with some aspects of the disclosure.

FIG. 10 is a diagram illustrating a diffusion model in accordance with some aspects of the disclosure.

FIG. 11 is a flow diagram illustrating a method in accordance with some aspects of the disclosure.

FIG. 12 is a flow diagram illustrating a method in accordance with some aspects of the disclosure.

FIG. 13 illustrates a method of automatically, or programmatically, generating additional input-output data sets in accordance with some aspects of the disclosure.

FIG. 14 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

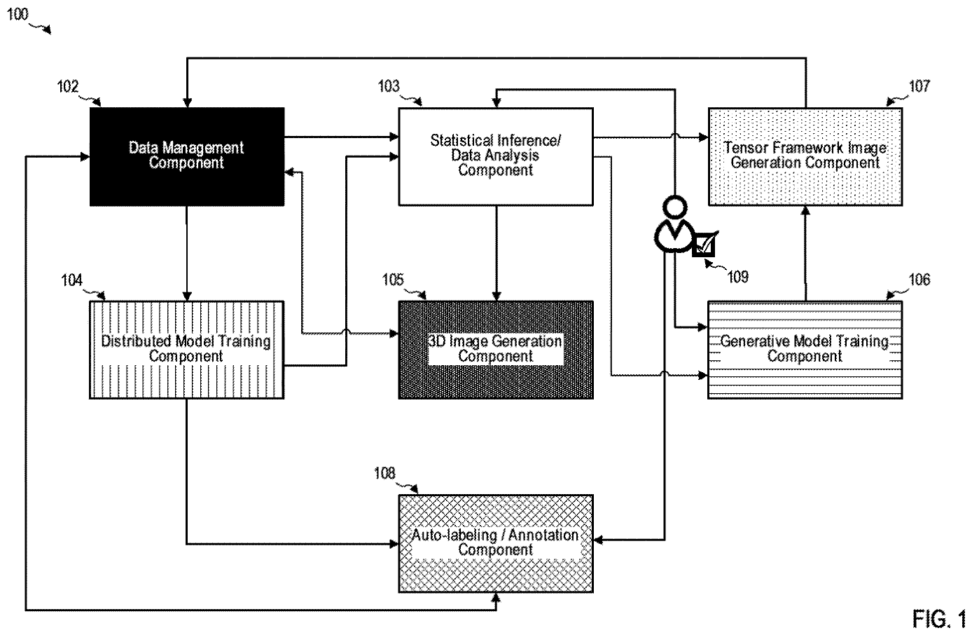

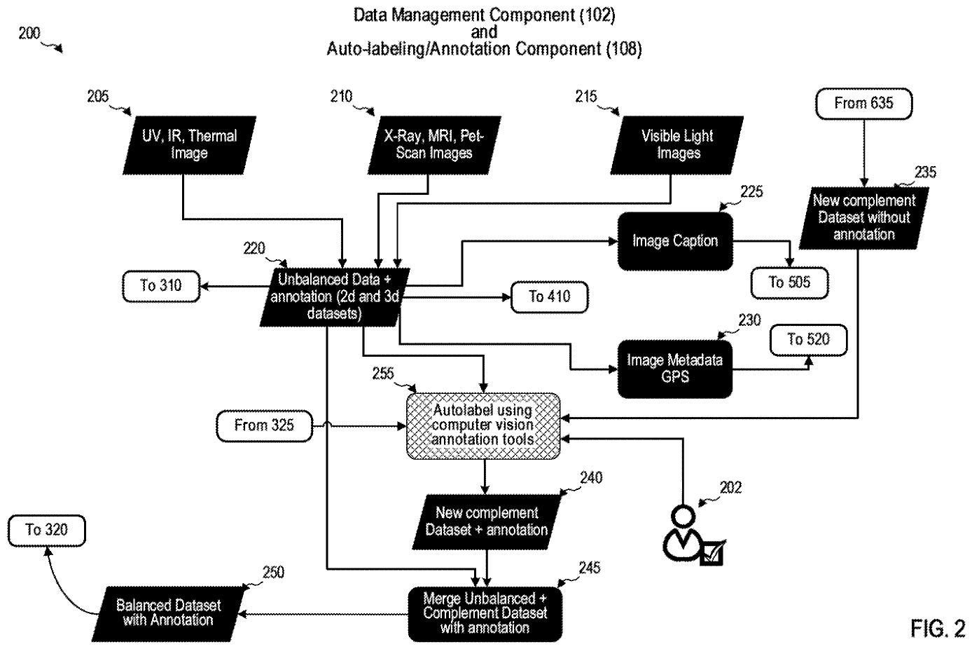

FIG. 1 is a diagram 100 illustrating a set of functional components of a system in accordance with some aspects of the disclosure. The system in some aspects, may include a data management component 102, a statistical inference/data analysis component 103, a distributed model training component 104, a three-dimensional (3D) image generation component 105, a generative model training component 106, a tensor framework image generation component 107, and an auto-labeling/annotation component 108. Some components (e.g., statistical inference/data analysis component 103, generative model training component 106, and auto-labeling/annotation component 108) may interact with a user 109. The different functions and sub-components of the components illustrated in diagram 100 are discussed in relation to FIGS. 2-6 below.

The data management component 102, in some aspects, may manage multiple types of data sets and metadata associated with the different types of data sets. FIG. 2 is a diagram 200 illustrating some aspects of the data management component 102 and auto-labeling/annotation component 108 of FIG. 1 in accordance with some aspect of the disclosure. The data management component 102, in some aspects, may be associated with multiple types of data such as ultraviolet (UV), infrared (IR), or thermal images (e.g., UV/IR/thermal image data 205); X-ray, magnetic resonance imaging (MRI), or positron emission tomography-scan (PET-scan) images (e.g., X-ray/MRI/PET-scan image data 210); or regular images (e.g., visible light image data 215). The different images may be monochromatic (e.g., gray-scale) or multi-channel (e.g., blue/red or red/green/blue (RGB)). The image data may further include 2D or 3D images (e.g., RGB and depth). The data management component 102 may produce an aggregated data set (e.g., unbalanced data set 220) including one or more of the data types (or other types of data to which the methods discussed in the disclosure may be applied).

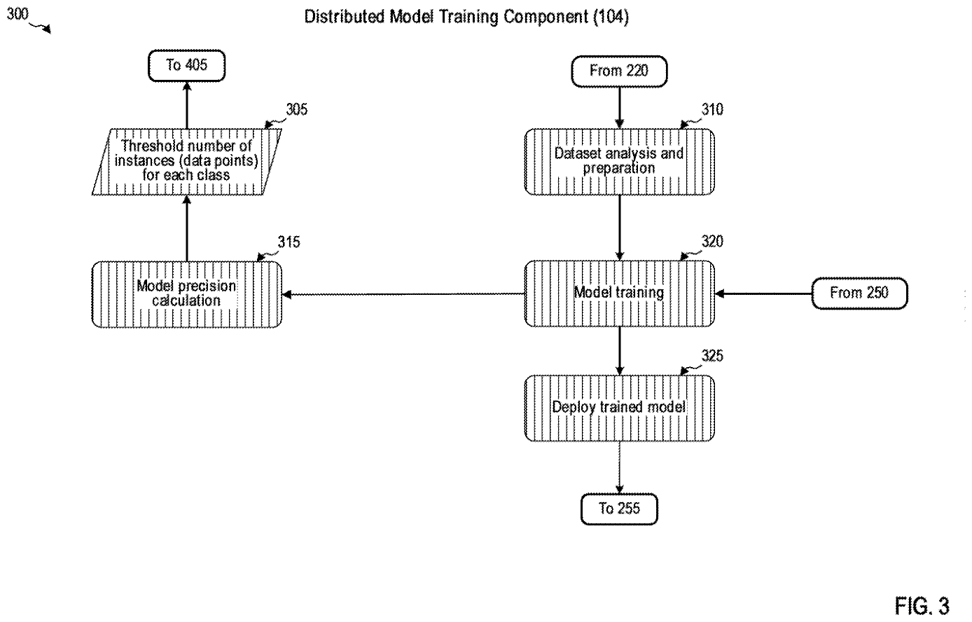

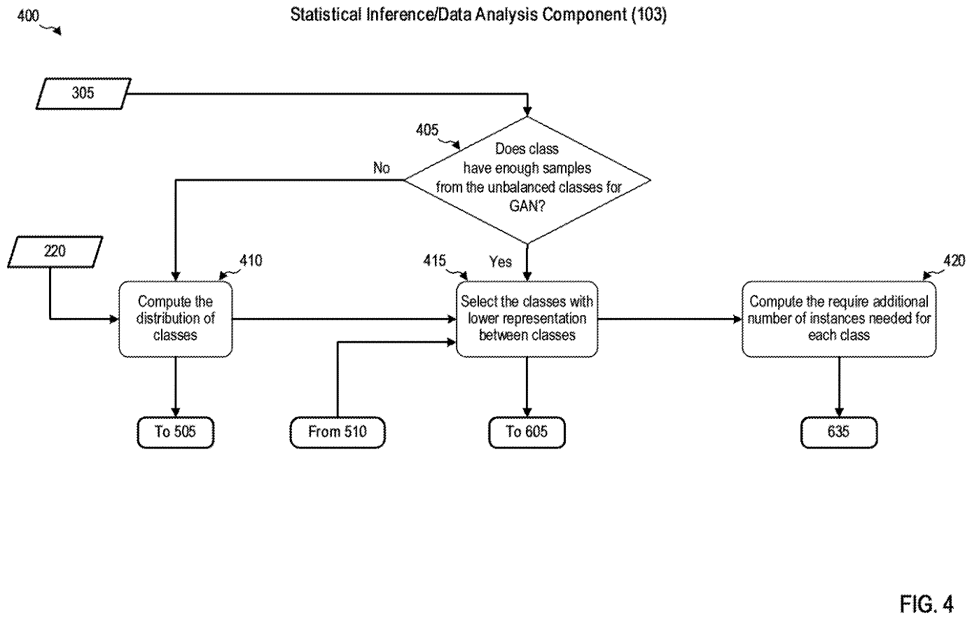

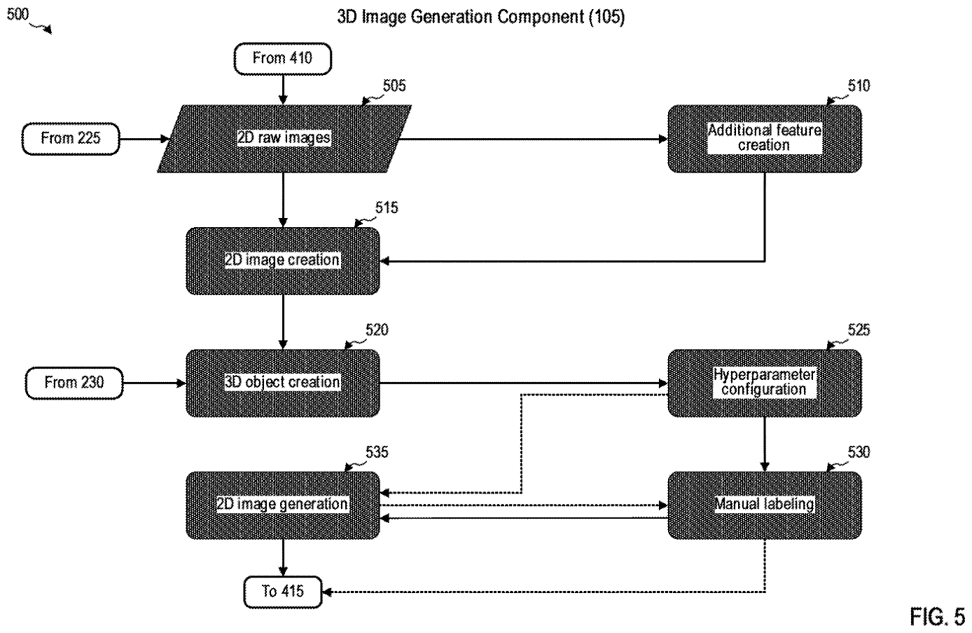

The unbalanced data set 220, in some aspects, may be provided as input for an image captioning operation 225. An image captioning operation 225, in some aspects, may provide additional information about a location where the image was taken or other context for the image. The captioned image data produced by image captioning operation 225, in some aspects, may be provided as input to element 505 of FIG. 5 as will be explained below. In some aspects, the unbalanced data set 220 may additionally, or alternatively, be provided to an image metadata operation 230 to add metadata such as location (e.g., GPS), camera type, focus length, device maker, device model, F Number, lens dimensions or other metadata (e.g., to be used to compute the distance between the camera and the object). The image data with metadata produced by image metadata operation 230, in some aspects, may be provided as input to element 520 of FIG. 5 as will be explained below. The unbalanced data set 220 may further be provided to one or more of auto-labeling/annotation component 255 and/or merging component 245 to generate a balanced data set with annotation 250 that may in turn be provided to element 320 of FIG. 3. The unbalanced data set 220, in some aspects, may further be provided to elements 310 and 410 of FIGS. 3 and 4. In some aspects, the unbalanced data set 220 may be provided to other elements of the FIGS. 2-6 in association with different stages (or functions) of the method.

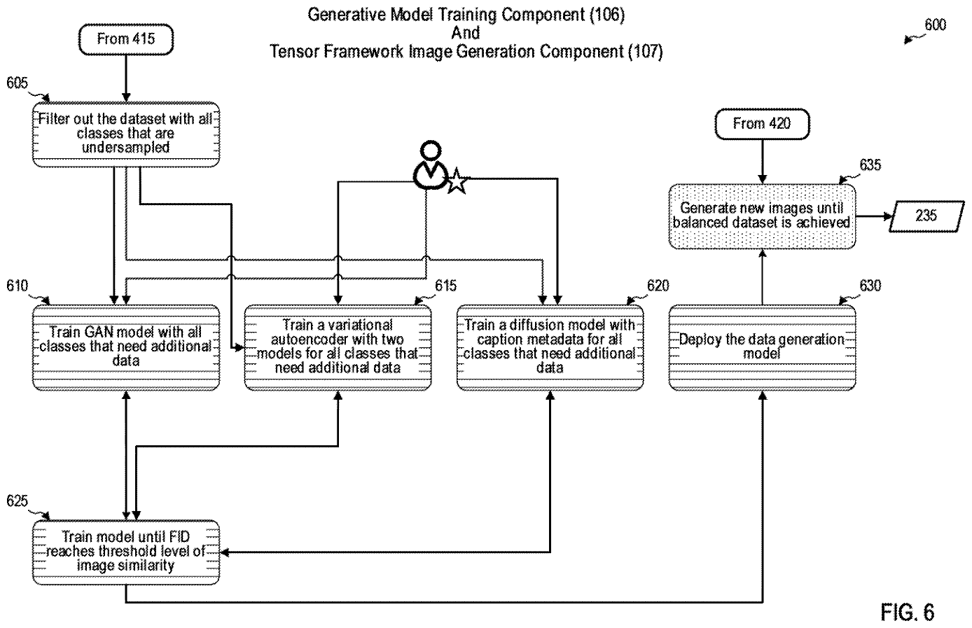

In some aspects, after the generation of additional set of images for balancing the data sets at element 635 of FIG. 6 discussed below, the additional set of images or data (e.g., a new complement data set 235) may be provided, along with the unbalanced data set 220, to the auto-labeling/annotation component 255. The auto-labeling/annotation component 255, in some aspects, may annotate un-annotated (or unlabeled) data from the unbalanced data set 220 and the new complement data set 235 to produce a new annotated complement data set 240. In some aspects, the auto-labeling/annotation component 255 may use a machine-trained model received from an element 325 of FIG. 3. The unbalanced data set 220 (after annotation) and the new annotated complement data set 240 may then be provided to a merging component 245 to produce a balanced data set with annotation 250. In some aspects, the auto-labeling may be validated by a user 202.

Biased data sets such as unbalanced data set 220 are a very common problem in data science. For example, the unbalanced data set 220, in some aspects, may have many more examples of properly functioning industrial components than examples of industrial components with defects or experiencing failure events. In some cases, the unbalanced data set 220 is provided to element 310 during an initial training of a model (e.g., a machine-trained model) as described in relation to FIG. 3. FIG. 3 is a diagram 300 illustrating a set of operations associated with the distributed model training component 104 in accordance with some aspects of the disclosure. In some aspects, an initial model training may begin by receiving the unbalanced data set 220 and using a preparation operation 310 to identify, for the unbalanced data set 220 (e.g., an initial set of training data), at least one classification (e.g., a label or class) in a plurality of classifications associated with the unbalanced data set 220 that is under-represented (and conversely that another classification is over-represented). The dataset analysis and preparation operation 310 may then perform one or more of a down-sampling of the data associated with the over-represented classification or an up-sampling of the data associated with the under-represented classification (e.g., on the unbalanced data set 220) to produce a more balanced set of data for training. The up-sampling, in some aspects, may include duplicating a subset of data associated with an under-represented class, while down-sampling may include ignoring a subset of data associated with an over-represented class (e.g., images associated with, or labeled as, normal). For example, in the context of industrial applications in which defects and/or failure may be rare, the under-represented classification may be associated with images classified, or labeled, as a defect or failure event, while images classified, or labeled, as normal may be over-represented.

For the initial model training, the unbalanced data set 220 may be provided for model training operation 320 after the dataset analysis and preparation operation 310. In some aspects, for a subsequent training, the balanced data set with annotation 250 may be provided for model training and/or updating (refinement). The input data sets (e.g., either unbalanced data set 220 or balanced data set with annotation 250), in some aspects, may be divided to produce a training data set and a validation and/or test data set. The model training operation 320 may produce a model that accepts input image data (of whatever type or types it has been trained on and/or configured for) and provide a classification into two or more classes. For example, the different classifications in an industrial context may include: normal/OK, a first type of defect (indicating a potential or probable failure in the near term), or a second type of defect (total failure or failure event). The model training operation 320, in some aspects, may perform an iterative model training operation to train a model (e.g., to adjust weights of a neural network or other parameters for other machine-trained models) until some set of criteria are met, such as a threshold accuracy (e.g., greater than 95% of the samples correctly labeled) for the model trained using the training data set when used to analyze images in the validation and/or test data set. The trained model may be provided for a model deployment operation 325 that will deploy the model by providing the trained model to the annotation component 255 of FIG. 2 as an object detection model used to automatically label input images (or other data types on which it was trained). In some aspects, the trained model based on the unbalanced dataset may be a starting point for the model labeling. For example, using the trained model, the system may label generated images in a current iteration. The generated and labeled images for a current iteration, in some aspects, may be used for subsequent iterations of the model training operation 320.

In some aspects, the model training associated with model training operation 320 may be based on a genetic algorithm. The genetic algorithm (as an example of a machine-learning algorithm for generating a machine-trained model), in some aspects may be set up using hyperparameter options. Hyperparameters in the context of a machine-learning algorithm, in some aspects, may generally refer to parameters used in the training of the model, e.g., to determine a magnitude of changes between steps or other aspects affecting the speed and/or a likelihood of identifying a local minimum of a cost function associated with the training, but not in the machine-trained model produced by the machine-learning algorithm. The hyperparameter options, in some aspects, may include a set of (pre-defined) random hyperparameters that may be used to produce a matrix of possible solutions. In some aspects, the genetic algorithm may apply a natural evolution strategies (NES) algorithm. The NES algorithm, in some aspects, may be an optimization algorithm that finds an optimized set of parameters for the machine-trained model. In some aspects, the NES algorithm may compute a gradient associated with changes (or mutations) to the model between each iteration to improve the model results by using information derived from both successful (e.g., better or more accurate) mutations and unsuccessful (e.g., worse of less accurate) mutations to a model in a previous iteration. The calculated gradient, in some aspects, may be a natural gradient. In some aspects, the calculated gradient may be used in conjunction with a Monte Carlo approximation to determine a set of mutations (or a set of parameters or likelihoods of particular mutations or types of mutations) for a subsequent generation/iteration of the genetic algorithm (e.g., the natural evolution strategies algorithm). The NES algorithm may be run iteratively until a stopping criteria is met (e.g., an accuracy threshold) as discussed above. In some aspects, using the natural gradient may prevent early convergence to local optima while ensuring large update steps.

The model training operation 320, in some aspects, may distribute the data (e.g., unbalanced data set 220 or balanced data set with annotation 250) into different agents and each agent may perform an independent training sub-operation. Each sub-operation may produce a different configuration of the machine-trained model and the set of different configurations of the machine-trained model, or the outputs of the set of different machine-trained models, may then be aggregated or combined in some way to produce an output for the set of different machine-trained models. In some aspects, a best machine-trained model of the set of different machine-trained models may be selected as the model for deployment. For each iteration, or generation, of the NES algorithm a cost function may be used to determine a fitness of each “child” compared to other “children” of a parent function or model. The cost function, in some aspects, may be based on precision, recall, and intersection over union.

The trained model, in some aspects, may be provided for a model precision calculation operation 315. The model precision calculation operation 315 may compute a precision and/or accuracy for each identified class (or classification), e.g., normal/OK, the first type of defect, the second type of defect, or other label/class identified in the training data (e.g., the unbalanced data set 220 or the balanced data set with annotation 250). The model precision calculation operation 315, in some aspects, may further include a calculation of a threshold number 305 (or fraction/percentage) of instances (e.g., data points or images) for each class. The threshold number for each class may, in some aspects, be a minimum (or optimal) number, or fraction/percentage, of instances for a balanced data set (e.g., the balanced data set with annotation 250). A threshold number, or fraction/percentage, of instances may be used to identify classes that are over-represented and/or under-represented based on a total number of instances included in the complete data set (e.g., unbalanced data set 220 for an initial training or balanced data set with annotation 250 for a subsequent training). In some aspects, the total number of instances associated with the over-represented class may be used to determine a minimum (or optimal) number of instances for the under-represented classes (e.g., based on a determined minimum fraction/percentage of instances). The threshold number may then be provided to element 405 of FIG. 4 as a parameter of a data generation process.

FIG. 4 is a diagram 400 illustrating a set of operations associated with the data analysis component 103 in accordance with some aspects of the disclosure. The set of operations, in some aspects, may include a determination 405 based on the threshold number 305 and a number of instances associated with each (e.g., one or more) under-represented class whether a sufficient number of instances (images or data points) exist in the data set (e.g., the unbalanced data set 220 or the balanced data set with annotation 250) for a generative process (e.g., a generative adversarial network (GAN) and/or variational autoencoder, a conditional latent diffusion model). If the determination 405 identifies that there are not enough instances associated with a particular under-represented class, the method, in some aspects, may proceed to a process based on a human-computer process using 3D applications, the insufficient number of datapoints (instances), and subject matter experts (SMEs) to generate additional images to use for model training as described in relation to FIG. 5 (and a subsequent generative process, e.g., as described in relation to FIG. 6, to generate further additional images for model training). Based on the identification that there are not enough instances associated with a particular under-represented class, the method may proceed to a computation of the distribution of classes 410. The computation of the distribution of classes 410, in some aspects, may be based on the unbalanced data set 220 and, for each identified class, the method may proceed to element 505 of FIG. 5 to generate additional images as described in relation to FIG. 5 below.

If the determination 405 identifies that there are enough instances associated with a particular under-represented class, the method, in some aspects, may proceed to a selection of an under-represented class 415 for a generative process, e.g., as described in relation to FIG. 6, to generate further additional images for model training. The selection of the under-represented class 415 may further be informed by the computation of the distribution of classes 410 and the 2D images generated by element 510 of FIG. 5 to identify the under-represented classes. Based on the selection of the under-represented class 415 (and the number of instances generated by the model training of FIG. 5), the method may proceed to a generative process for generating additional images (e.g., represented by element 605) of FIG. 6. The generative process, in some aspects, may be a human-computer process using deep learning, the datapoints (instances) of associated with the under-represented class, and SMEs. For each selected class, the method may proceed to a balancing computation 420 that computes a number of additional instances for balancing the representation of the selected class to provide to a new instance generation operation 635 of FIG. 6 (e.g., for the new instance generation operation 635 to determine when to stop generating additional instances and/or data points).

FIG. 5 is a diagram 500 illustrating a set of operations associated with the image generation component 105 in accordance with some aspects of the disclosure. The set of operations illustrated in diagram 500, in some aspects, may be based on a number of 2D images of a same object that may be used to render a 3D virtual object representing the object. In some aspects, the 3D virtual object may be generated a generative model for high quality 3D images (or virtual objects). The generative model, in some aspects, may include a combination of a convolutional neural networks (CNNs) and generative neural networks (e.g., GANs) which may be used to generate scenarios of different situations for images. The different scenarios, in some aspects, may be associated with different locations and/orientations of a virtual camera for synthesizing 2D images of the 3D virtual object. In some aspects, the different scenarios may further be associated with different conditions such as different lighting or light sources and, in conjunction with a morphism algorithm, different conditions of the 3D virtual object such as age or material as described below in relation to 2D image creation operation 515. A first CNN, in some aspects may be used for generation of geometry differentiation surface representation, that will give to the images the geometry aspects of the hidden faces of the object. A second CNN, in some aspects, may be used for the generation of the texture of the images. For example, the second CNN may be used to apply color and a 2-D silhouette to the image using a differentiable rendering. In some aspects, both the first and second CNNs may use pre-trained models that have the representation of the geometry and the texture of the objects.

For example, the diagram 500 illustrates that the additional image generation may begin with a set of 2D raw images 505 (where the images may be any of the types described above). The set of 2D raw images 505, in some aspects, may include subsets of images associated with a corresponding object (e.g., industrial components) in a set of one or more different objects. In some aspects, a subset of images associated with a particular object in the set of 2D raw images 505 may include multiple images taken from different angles and/or camera positions, where the different angles and/or camera positions may be known based on a caption provided by image captioning operation 225. The different objects, in some aspects, may all be objects associated with a particular label, class, or classification, and the process described below may be performed for each label, class, or classification determined to not have enough instances to perform a generative process for generating additional images.

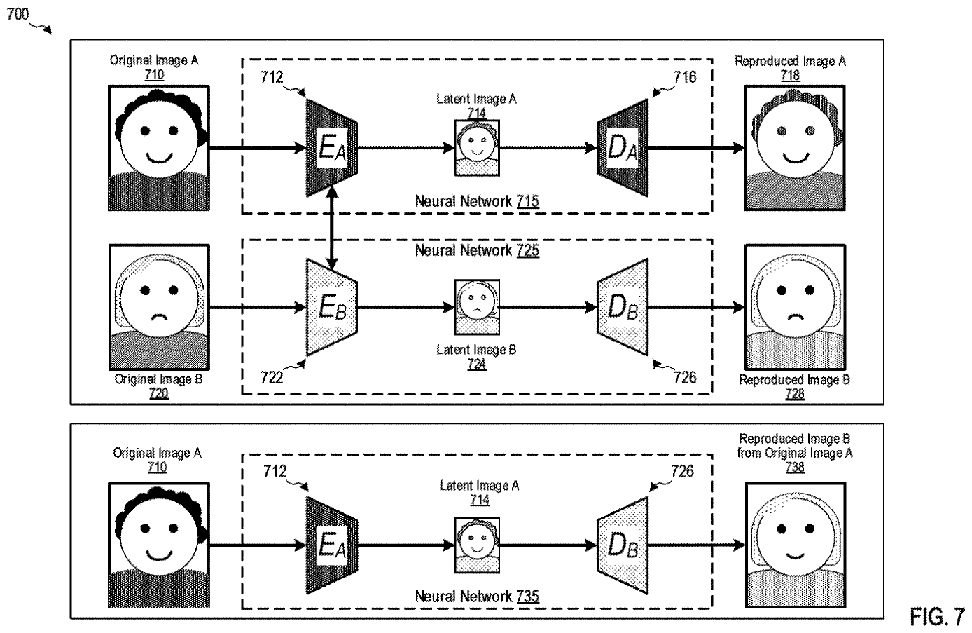

For each object associated with a subset of images of the set of 2D raw images 505, the method may provide the subset of images of the set of 2D raw images 505 to an additional feature creation operation 510 to create (generate or identify) additional features (e.g., parameters and/or modification algorithms) for the object for mimicking aging (e.g., exposure to one or more environmental conditions for one or more lengths of time) or for modifying an image to represent a similar object made from a different material, e.g., using a morphism auto-encoder as described below in relation to FIG. 7. The subset of images of the set of 2D raw images 505 may also be provided (along with the features, or modification algorithms, provided by the additional feature creation operation 510) to a 2D image creation operation 515. The 2D image creation operation 515, in some aspects, may generate additional 2D images for different feature sets (e.g., different combinations of environmental conditions, durations, and material type) based on the subset of images associated with the particular object and the additional features.

In some aspects, the subset of images associated with the object of the set of 2D raw images 505 (and each set of additional 2D images for the different feature sets) may be provided to a 3D object creation operation 520 to generate a 3D model of the object (or a 3D model for the object for each of the different feature sets). The 3D object creation operation 520, in some aspects, may also receive image metadata from image metadata operation 230 to use to generate the 3D model of the object. The generated 3D model (or 3D models) may then be provided for a hyperparameter configuration operation 525 to generate one or more sets of parameters to use with the 3D model to generate additional 2D images (instances and/or data points). A set of (hyper) parameters generated at hyperparameter configuration operation 525, in some aspects, may include a brightness, a lightness, or other (hyper) parameters that may affect an image produced from the 3D model. The 3D model (or models) may then be labeled and/or classified by a subject matter expert (SME) (e.g., an input from the SME may be received) as part of a manual labeling operation 530.

In some aspects, the set of (hyper) parameters may include one or more of parameters associated with the visual qualities of the images or objects in the images such as (1) a brightness of the object associated with a visual perception of a level at which the object appears to be radiating or reflecting light, (2) a contrast associated with a difference in luminance or color that makes an object distinguishable from other objects in an image, (3) a saturation associated with the intensity of the color of the image, (4) a color scheme associated with being a color image or a grayscale image, (5) a hue associated with (altering) color channels of the input image, (6) and a blur associated with a mixing of nearby pixel values to mimic a lack of focus. The set of (hyper) parameters, in some aspects, may also include one or more of parameters associated with the orientation or composition of an image such as (1) a rotation of the image, (2) a flip of the image, (3) a cropping of the image, (4) a resizing of the image (e.g., adjusting an aspect ratio), (5) a cutout (e.g., randomly covering an area of the image with a set of random pixels or pixels having a mean pixel value of the training set), (6) a mosaic associated with tiling different images to create a new image, (7) a cutmix associated with randomly cutting a portion of a first image and placing it over another image, or (8) a mixup associated with generating a weighted combination of random image pairs. These sets of (hyper) parameters may provide more samples for a dataset and expose the model to a new set of data. This larger number of samples, in some aspects, improves model generalization by serving as a regularization of the model avoiding overfitting. Accordingly, for each original image (either a raw 2D image or a synthetic 2D image produced from the 3D model) several images may be created, in some aspects, based on the combinatory (hyper) parameter options the user selects.

Based on the (hyper) parameters generated at hyperparameter configuration operation 525 (based on a user selection) and the labels and/or classification applied at manual labeling operation 530, a set of additional 2D images may be generated at 2D image generation operation 535. The set of additional 2D images, in some aspects, may include multiple additional synthetic images (e.g., from multiple virtual camera positions and/or orientations relative to the 3D model) for each object associated with a subset of images of the set of 2D raw images 505. The multiple synthetic images, in some aspects may further be multiplied by applying morphisms (sets of features or other modifications/adjustments based on an autoencoder) and a set of operations based on one or more of the (hyper) parameters. The set of additional images, in some aspects, may simulate several physical scenarios associated with images to use in training the machine-trained auto-labeling model and a more accurate and versatile (e.g., not over-fit) machine-trained model.

In some aspects (indicated by a dotted connector), the manual labeling operation 530 may be performed after the 2D image generation operation 535 to ensure that the label is accurate for each particular image (or set of images associated with a same perspective) and not merely for the object as a whole (e.g., to ensure that a defect associated with the object is detectable/identifiable based on the viewing angle, feature set, and/or (hyper) parameters used to produce the image). In some aspects, the SME may label, via the manual labeling operation 530, after the creation of a set of core images (e.g., the 2D images produced from the 3D model) that will be used for the data generation (and augmentation). For example, the SME may create a seed annotation for each core image. This seed annotation, in some aspects, may be associated with the images created in the data generation process described above (or as described below in relation to the generative processes discussed in relation to FIG. 6). For example, if the image A is created with a bounding box (x₁, y₁, x₂, y₂) and class e, the images created using image A based on the morphisms or (hyper) parameters discussed above may have the same annotation, e.g., bounding box (x₁, y₁, x₂, y₂) and class c. The seed annotation, in some aspects, may then be the reference for all images created from the original image and the images may be included in the set of data (e.g., unbalanced data set 220 or balanced data set with annotation 250) along with an indication of the seed annotation. The additional images (or information regarding the number of additional images produced associated with each label and/or classification) may be provided to the selection of the under-represented class 415 to use to select an under-represented class for which to perform a generative process for generating additional images.

FIG. 6 is a diagram 600 illustrating a set of operations associated with the generative model training component 106 and tensor framework image generation component 107 in accordance with some aspects of the disclosure. The diagram 600 illustrates that the set of operations may begin by receiving, for a filtering operation 605, a selection of a class from the selection of the under-represented class 415 and filtering the unbalanced data set 220 (e.g., either the original image data or the original image data and the additional images generated as described in relation to FIG. 5) to isolate data sets for at least one (or each) under-represented label/class/classification. In some aspects, the filtering operations may include a process described by the following pseudocode: g=max(xₖ) and rₖ=g−xₖ, for k∈[1, n], where n is the number of classes, xₖ is the number of records for a class (k), g is the number of samples needed for each class, and rₖ is the number of elements needed to up sample for the kth class. The example filtering process results in a balanced data set including a same number of instances (data points such as images, video, and so on) for each class.

The filtered data may be provided to one or more of a GAN training operation 610, a variational autoencoder training operation 615, and a diffusion model training operation 620, or other training operation for a model/network to generate images. In some aspects, after an iteration of a training operation (one of GAN training operation 610, variational autoencoder training operation 615, or diffusion model training operation 620), one or more images produced by the trained model or network may be provided to a similarity determination component 625. The similarity determination component 625 may perform a similarity determination (e.g., a Fréchet inception distance (FID) or other measure of similarity) to determine if the images produced by a machine-trained model or network are similar enough (e.g., if the FID is below a threshold) to a set of test images generated to terminate the training. The similarity determination component 625, in some aspects, may additionally, or alternatively be used to determine whether to use each of the machine-trained model and/or networks.

If the similarity determination component 625 determines that the generated images are not similar enough, the similarity determination component 625 may indicate for an associated training operation to continue training (e.g., perform an additional iteration of a training process). This process may be iterated until a similarity score meets a configured threshold (e.g., if the FID<threshold). If the similarity determination component 625 determines that the generated images are similar enough for one or more of the machine-trained models or networks, the associated one or more machine-trained models or networks may be deployed by a model deployment component 630. Once deployed, the one or more machine-trained models or networks may be used for a new instance generation operation 635 corresponding to tensor framework image generation component 107. The new instance generation operation 635, in some aspects, may generate new instances (e.g., images or data points) for under-represented labels/classes/classifications. The new instance generation operation 635 may generate additional instances based on the number of additional instances for balancing the representation of the selected class provided by the balancing computation 420. The new instance generation operation 635, in some aspects, may produce the new complement data set 235 of FIG. 2 (e.g., a new data set to complement, or balance, the unbalanced data set 220). As indicated in FIG. 2, the new complement data set 235, in some aspects, may not be labeled/classified/annotated. As discussed above in relation to FIGS. 2 and 3, the data generated by the new instance generation operation 635 may be added to the unbalanced data set 220 to produce a balanced data set that may then be used to retrain and/or update (e.g., refine) a model initially trained on the unbalanced data set 220.

FIG. 7 is a diagram 700 illustrating elements of a morphism in accordance with some aspects of the disclosure. Morphism, in some aspects, is applied using a deep learning technique (e.g., a siamese network or twin networks) including training two different neural networks (e.g., a first neural network 715 and a second neural network 725) with encoder and decoder architecture at the same time. The set of weights (e.g., the configuration of the network) associated with the encoder layer (e.g., with the encoder (E_{A}) 712 and the encoder (E_{B}) 722), in some aspects, may be a shared set of weights. For example, the shared set of weights may be trained to recognize elements (associated with latent image 714 and latent image 724) that are common to a set of images.

In some aspects, a first group of images of a first object may be used to train a first neural network (as an example of a machine-trained network) while a second group of images of a second, different object may be used to train a second neural network. The first and second neural networks (e.g., first neural network 715 and second neural network 725, respectively) may be two autoencoder neural networks that share weights for an encoder (e.g., a neural network or other machine-trained network or model) while having independently-trained decoders (e.g., neural networks or other machine-trained networks or models). The first and second neural networks 715 and 725, respectively, may be trained to receive input data (e.g., images) from a corresponding set of training data, produce a representation of the input data (e.g., a latent image) using an encoder network, and reproduce the input data from the representation of the input data using a corresponding decoder network. For example, the encoder (e.g., encoder (E_{A}) 712 or encoder (E_{B}) 722), in some aspects, may be used to process input images (original image 710 or original image 720) to determine features (e.g., latent images 714 and 724) that may be used to generate an approximation of the original images (e.g., reproduced image 718 or reproduced image 728) using an associated decoder (e.g., decoder (D_{A}) 716 or decoder (D_{B}) 726). The training may define a metric for the accuracy of the reproduction ((e.g., an FID or other similarity metric) and a threshold similarity for a trained network (auto-encoder).

The morphism, in some aspects, may generate additional data for an under-represented label/class/classification by using the neural network 735 to process a first data set (a first set of images) used to train the first neural network 715 to produce a set of data (a third set of reproduced images including reproduced image 738) that shares features of the second set of data used to train the neural network 735 (e.g., the decoder (D_{B}) 726). The neural network 735, in some aspects, may effectively be the second neural network 725 trained based on the second data set including original image 720, because encoder (E_{A}) 712 is the same as encoder (E_{B}) 722 and the decoder is the decoder (D_{B}) 726 of the second neural network 725). Similarly, the first neural network 715 may be used to process the second set of data to produce a fourth set of reproduced data (additional images) that shares features of the first set of data. For example, in some aspects, a first and second auto-encoder network (e.g., first and second neural networks 715 and 725) may be trained using a first set of images (e.g., including the original image 710) of a porcelain insulator with partially broken discs and a second set of images (e.g., including the original image 720) of glass insulators, respectively. The second neural network (associated with the glass insulators) may then be used to generate images mimicking a broken glass disk insulator from images of broken porcelain insulators. Such reproduced images may enable, or allow for, rare events such as a partial break of a glass disk insulator to be accounted for in the training of a machine-trained model for labeling images. For example, because porcelain insulators have been used for a longer time than glass disk insulators and glass disk insulators are more likely to experience complete failure, the amount of data associated with a partial break of a glass disk insulator may be too small to reliably train a machine-trained model to recognize such defects and/or failure events. The selection of the particular input image set and trained auto-encoder, in some aspects, may be based on the type of image to be produced, e.g., the type of image identified as being under-represented in the unbalanced data set 220 of FIG. 2. For example, in some aspects, both trained auto-encoders may be used to generate additional data if the different input data sets both have features that are less likely to exist (or that exist in a smaller number) in the other data set but that a user would like to account for, or consider, in training an auto-labeling machine-trained model.

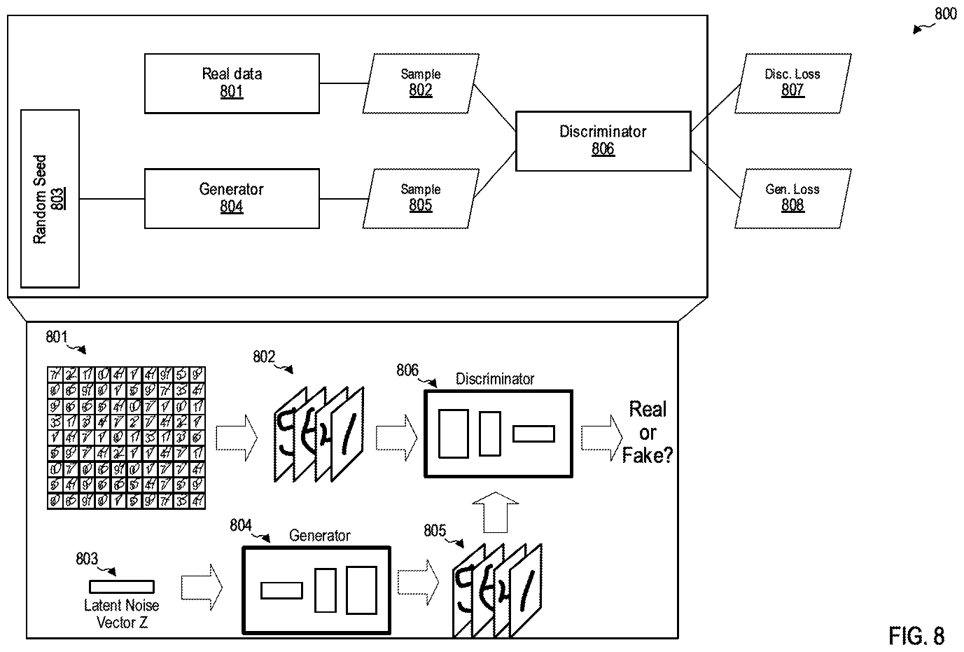

FIG. 8 is a diagram 800 illustrating a GAN in accordance with some aspects of the disclosure, GANs, in some aspects, may be neural network (NN) architectures that use two NNS, a discriminator NN 806 and a generator NN 804, to generate synthetic instances of data (e.g., samples 802) based on real data 801. In training the GAN, the data from an initial dataset (e.g., unbalanced data set 220 of FIG. 2) may be prepared by splitting input data (e.g., images, videos, audio, and so on included in real data 801) from associated output (e.g., labels/classes/classifications). The split/separated data may then be used to train the GAN. The GAN, in some aspects, may be trained in a conditional mode using annotation data to distinguish between labels/classes/classifications. In some aspects, the GAN may be trained in an unconditional mode that ignores labels/classes/classifications. Both the conditional mode and the unconditional mode of training may be used, in some aspects, followed by a selection of a trained model with better results (e.g., for a set of test results).

The training of a GAN, in some aspects, may include one or more iterations of alternately training the generator NN 804 and the discriminator NN 806. For example, for training a generator NN 804, a discriminator NN 806 may be held constant while the generator NN 804 (e.g., weights associated with neurons of the generator NN 804) is updated based on the results of a discrimination/analysis performed by the discriminator NN 806. The results of the discrimination/analysis performed by the discriminator NN 806 on samples 805 produced by the generator NN 804 (based on a random seed 803) during a generator NN 804 training, in some aspects, may be associated with generator loss 808 that is used as feedback for updating the generator NN 804. The feedback, in some aspects, may be used with a form of gradient descent training (e.g., minibatch stochastic gradient descent training) or other training methodology. Similarly, the generator loss 808 may be calculated using any appropriate loss function. After a training period for the generator NN 804, a training period for the discriminator NN 806 may be initiated.

During the training period for the discriminator NN 806, the generator NN 804 may be held constant while the discriminator NN 806 (e.g., weights associated with neurons of the discriminator NN 806) is updated based on the results of a discrimination/analysis performed by the discriminator NN 806. The results of the discrimination/analysis performed by the discriminator NN 806 on samples 805 produced by the generator NN 804 and on samples 802 from the real data 801 during the discriminator NN 806 training, in some aspects, may be associated with generator loss 808 that is used as feedback for updating the discriminator NN 806. The feedback, in some aspects, may be used with a form of gradient descent training (e.g., minibatch stochastic gradient descent training) or other training methodology. Similarly, the discriminator loss 807 may be calculated using any appropriate loss function. Multiple iterations of alternatively training the generator NN 804 and the discriminator NN 806 may be performed until the images generated by the generator NN 804 are indistinguishable from real data by the discriminator NN 806. Once the generator NN 804 is trained, the generator NN 804 may be used to generate additional data (e.g., input-output data sets). For example, for a generator NN 804 that is trained for a first class (based on data associated with a first class) may be used to generate additional input data that is associated with a label/class/classification of the first class to produce an input-output data set.

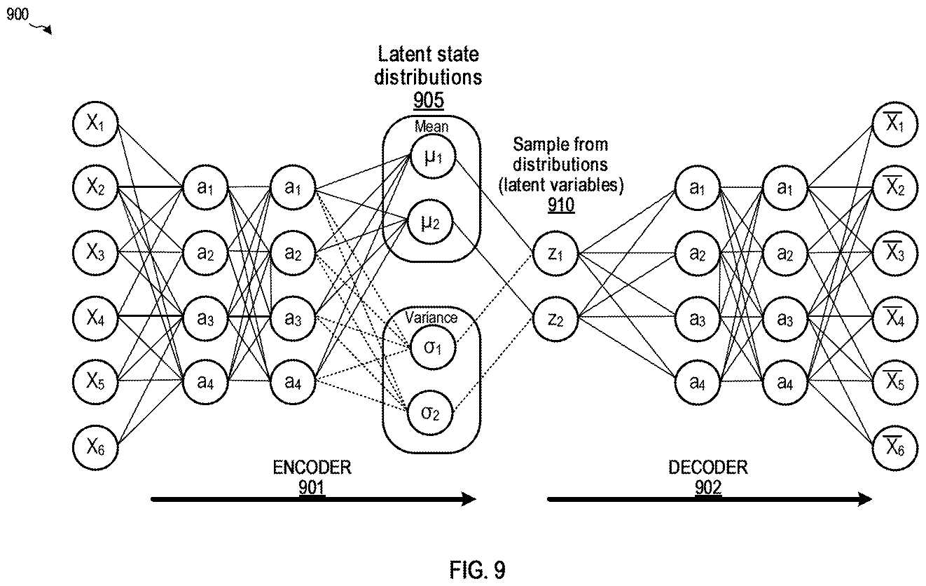

FIG. 9 is a diagram 900 illustrating a variational autoencoder (VAE) in accordance with some aspects of the disclosure. In some aspects, a VAE consists of an autoencoder NN that creates a latent space (e.g., a latent state 905) from a decoder 902 and an encoder 901 and adds noise to the neural net (after the encoder 901 and before the decoder 902) to generate data. A VAE, in some aspects, is a type of generative model that uses unsupervised techniques to model the distribution of the input data and then generate the new images using a random data generation. In some aspects, a VAE is a principled framework for learning deep latent-variable models and corresponding inference models. Accordingly, the VAE, in some aspects, learns to rebuild an input image with noise using the decoder layer (e.g., decoder 902).

The VAE model, in some aspects, may include a probabilistic encoder layer (encoder 901), a layer of latent variables (z) (layer variables 910) and a probabilistic decoder layer (decoder 902). The VAE, in some aspects, learns a joint probability distribution of the observable data and the latent space giving the model parameters using backpropagation. In some aspects, a Kullback-Leibler (KL) divergence may be used to calculate a distance between the approximate posterior probability and the true posterior probability. The KL divergence may also be used to compute a gap between Evidence of Lower Bound (ELBO) and tightness of the bound. The objective function of VAE, in some aspects, is the maximization of Evidence of Lower Bound (ELBO), and the ELBO approach, in some aspects, may be directed to finding one or more optimal parameters for approximate and exact posterior probability in a way that maximizes the difference of the log-likelihood of the observed dataset and minimizes the divergence between of the approximate posterior probability from the exact posterior probability (e.g., using a differentiable loss function such as θ*, Φ*=argmax L_{θ,φ}(x)). To search the space of options of the parameters and maximize the ELBO function, in some aspects, a gradient descent optimization technique is used. In some aspects, may use other loss functions and/or methods of searching the space of options for the parameters.

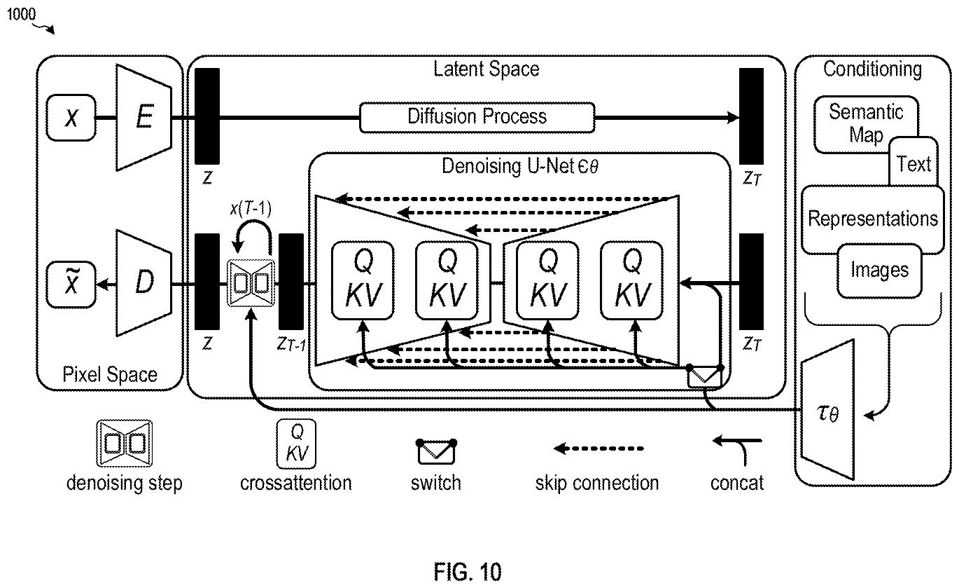

FIG. 10 is a diagram 1000 illustrating a diffusion model in accordance with some aspects of the disclosure. A diffusion model, in some aspects, may include an encoder and decoder cross-attention architecture that learns how to reconstruct an original image as a noisy image. In some aspects, the diffusion model may be a conditional latent diffusion model (CLDM). In some aspects, the diffusion model may include probabilistic models designed to learn a data distribution p(x) by gradually denoising a normally distributed variable, which corresponds to learning the reverse process of a fixed Markov Chain.

In some aspects, based on the multiple types of machine-trained models for generating additional images, the system and/or method may generate N samples of each method (e.g., GAN, VAE, and CLDM) and compare the input data with the generated data from the 3 methods. The metric used for the comparison of the images, in some aspects, may be the FID that compares the distribution of the generated images with the distribution of the observed images. For example, the FID may be based on a distance equation,

$${d}_{0}^{2} ( {\sum }_{x} , {\sum }_{y} ) = tr ( {\sum }_{x} + {\sum }_{y} - 2 {( {\sum }_{x} {\sum }_{y} )}^{\frac{1}{2}} )$$

measuring the sum of elements of the diagonal of the results of the sum of covariance matrix X and Y minus two times the square root of the multiplication of the covariance matrix X and Y. The interpretation of the FID metric is the lower FID means the 2 distributions are similar, higher the FID means the two distributions are different.

In some aspects, the FID has 2 objectives in the system, the first one is during the model training as described in relation to FIG. 6 and the second is related to a generative model selection after the model training. For example, the FID, in some aspects, may serve as a stopping criterion for the model training. For comparing multiple types of machine-trained models, the method or system may compute a set of FIDs for each of the sets of generated data by the different machine-trained models. For example, for sets of generated images (or other data types) an

$${FID}_{i} ( {t}_{i}^{′} , t ) ,$$

i∈1, M, may be calculated for comparison, where M is the number of types of machine-trained models and t′ᵢ is a set of images generated by an i^{th} type of machine-trained model associated with a set of associated test images t. A best machine-trained model may, in some aspects, be selected based on the set of FIDs, e.g., by identifying a

$${Best}_{FID} = arg max ( {FID}_{i} ( {t}_{i}^{′} , t ) , i ∈ 1 , M )$$

In some aspects, the steps of the conditional model selection (i.e., selecting the best machine-trained model) are done for each label/class/classification. Accordingly, the selection of the best machine-trained model, in some aspects, may be based on

$${Best}_{{FID}_{k}} = arg max ( {FID}_{i , k} ( {t}_{i}^{′} , t ) ,$$

i∈1, M und k∈[1, n]) where k is a class identifier and n is the number of classes. After selecting the best machine-trained model for each under-represented class (or for a particular class) the selected machine-trained model associated with the class may be used to generate additional data (e.g., images, videos, audio, or other input or input-output data sets) for the class to balance the representation of the classes in the data set. The generated data may correspond to new complement data set 235 and may be associated with a label based on a class of images used as training data for a particular machine-trained model or based on a labeling performed by auto-labeling/annotation component 255 as described above. In some aspects, an application programming interface (API) architecture exposes the backend services from the system to easily allow external applications to submit all raw images (or other data types) and the system start to generate model training using raw and synthetic images and provide as output a new dataset with the mix of real and synthesized images (or other data types).

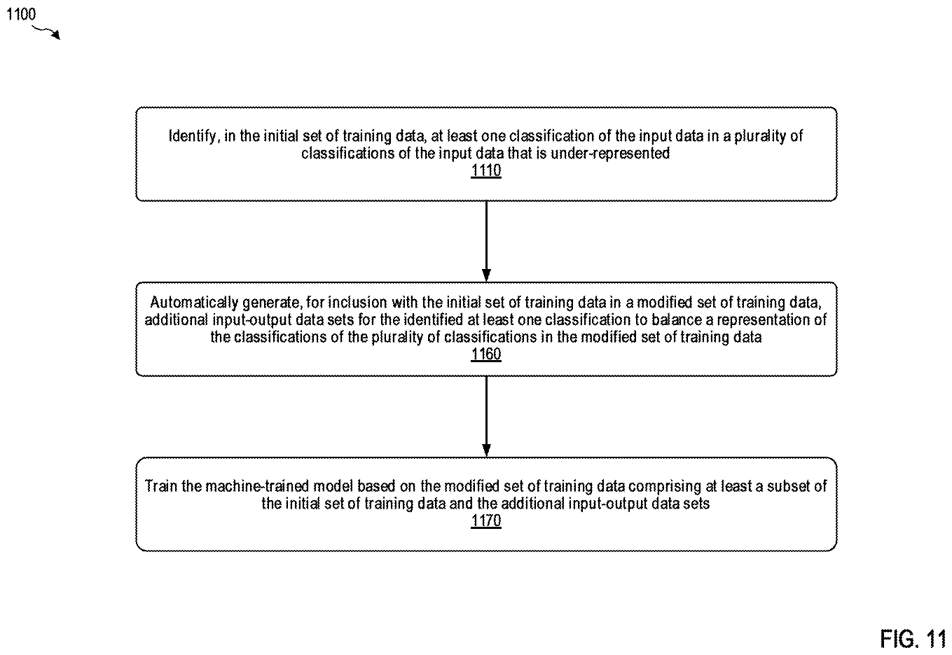

FIG. 11 is a flow diagram 1100 illustrating a method in accordance with some aspects of the disclosure. In some aspects, the method is performed by an inference engine or analysis apparatus (e.g., the system of diagram 100 or computer device 1405) that performs various analyses, machine-training operations, data augmentation operations, and inference (e.g., classification) operations based on collected data relating to industrial processes and/or components. The method may be for an industrial failure detection based on an initial set of training data. The initial set of training data may include a plurality of input-output data sets each comprising input data regarding an industrial object and output data regarding at least one classification of the input data. At 1110, the apparatus may identify, in an initial set of training data, at least one classification of the input data in a plurality of classifications of the input data that is under-represented. For example, referring to FIGS. 1 and 3, 1110 may be performed by the distributed model training component 104 or the dataset analysis and preparation operation 310 as discussed in relation to FIGS. 1-6. In some aspects, the input data may include at least one of image data, video data, audio data, x-ray data, MRI data, PET-scan data, infrared image data, UV image data, thermal data, or any other type of industrial data susceptible to analysis by machine-trained networks for classification.

In addition to identifying that at least one classification of the input data in a plurality of classifications of the input data that is under-represented, the apparatus may identify, in the initial set of training data, at least one additional classification of the input data in the plurality of classifications of the input data that is over-represented. In some aspects, the identification of the under-represented and under-represented classifications is based on a target distribution of data points (or instances, such as images or other data) among a plurality of classifications to produce an accurate machine-trained models. The target distribution, in some aspects, may indicate a range of acceptable distributions (fractions or percentages) for each classification in a plurality of classifications that may be converted into a number of data points based on a total number of data points in an initial (e.g., unbalanced) dataset for machine-learning-based model training. For example, referring to FIGS. 1 and 3, the identification of at least one additional classification of the input data in the plurality of classifications of the input data that is over-represented may be performed by the distributed model training component 104 or the dataset analysis and preparation operation 310 as discussed in relation to FIGS. 1-6.

Based on the identification of the under-represented classification at 1110 (and the over-represented classification), the apparatus may, in some aspects, update the initial data set by at least one of down-sampling data associated with the over-represented class or up-sampling data associated with the under-represented class. The down-sampling, in some aspects, may include removing (or ignoring) a first number of input-output data sets from the initial set of training data for training a machine-trained model. The up-sampling, in some aspects, may include duplicating data points associated with the under-represented classification to ensure there are enough examples of the under-represented classification to affect the configuration of the machine-trained model (e.g., a set of weights associated with the machine-trained model). For example, referring to FIGS. 1 and 3, the up-sampling and/or down-sampling may be performed by the distributed model training component 104 or the dataset analysis and preparation operation 310 as discussed in relation to FIGS. 1-6.

The apparatus, in some aspects, may train an initial machine-trained model based on the updated initial set of data. The initial training of the machine-trained model, in some aspects, may be based on a genetic algorithm as discussed in relation to FIG. 2. The initial training of the machine-trained model may be validated using a subset of the initial set of training data not used for training the machine-trained model (e.g., an associated set of validation data that is derived from a larger common data set that is sub-divided into the set of training data and the associated set of validation and/or test data). The validation, in some aspects, may be used to determine when to terminate a training operation and deploy the machine-trained model. For example, referring to FIGS. 1 and 3, the initial training may be performed by the distributed model training component 104 or the model training operation 320 as discussed in relation to FIGS. 1-6.

In some aspects, the apparatus may determine a minimum number of input-output data sets for each classification to produce a balanced set of training data. In some aspects, the determination may be based on the analysis performed at 1110. The minimum number of input-output data sets for a particular classification may be based on a desired (or known) ratio, fraction, and/or percentage associated with different classifications for generating (or training) an accurate model, and a total number of data points (e.g., input-output data sets or instances). For example, referring to FIGS. 1 and 3, the determination may be performed by the distributed model training component 104 or the model precision calculation operation 315 to produce the threshold number 305 as discussed in relation to FIGS. 1-6.

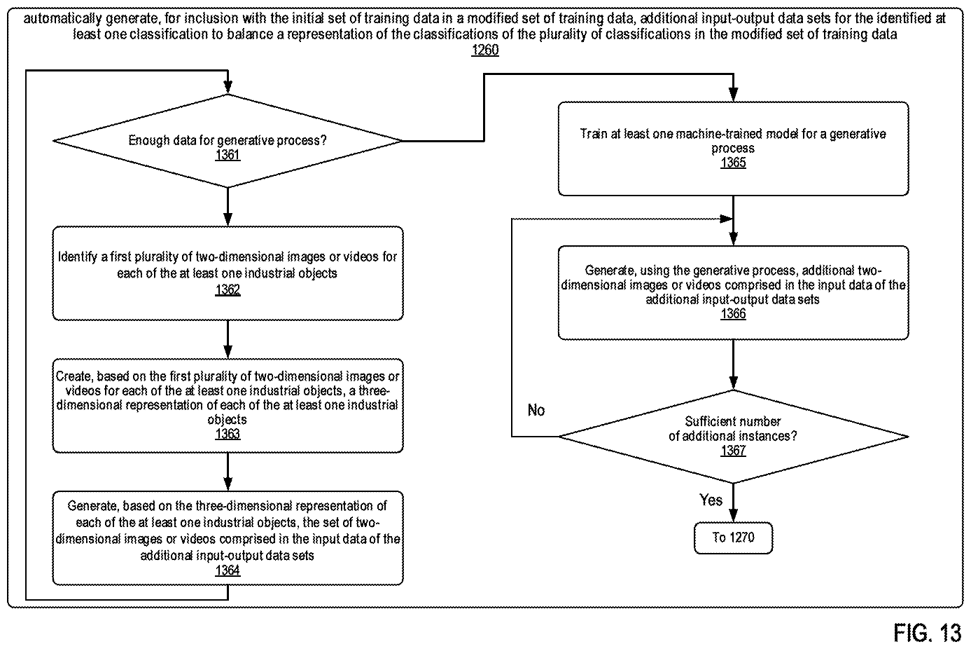

At 1160, the apparatus may automatically (or programmatically) generate, for inclusion with the initial set of training data in a modified set of training data, additional input-output data sets for the identified at least one classification to balance a representation of the classifications of the plurality of classifications in the modified set of training data. FIG. 13 illustrates a method of automatically, or programmatically, generating additional input-output data sets in accordance with some aspects of the disclosure. Referring to FIGS. 1 and 4-6, 1160 and the method of FIG. 13, in some aspects, may be performed by one or more of data analysis component 103, image generation component 105, generative model training component 106, tensor framework image generation component 107, elements 505-535 of FIG. 5, elements 605-635 of FIG. 6, or in association with determination 405. The generation of the additional input-output data sets, in some aspects, may include one or more different types of image generation algorithms. For example, a first set of non-machine-trained algorithms, e.g., a morphism-based algorithm or a 3D model generation-based algorithm as described in relation to elements 505 to 535 of FIG. 5, or a second set of machine-trained algorithms as described in relation to elements 605 to 635 of FIG. 6.

As part of generating the additional input-output sets at 1160, the apparatus may, at 1361, determine whether a sufficient number of input-output data sets associated with the under-represented classification (a currently selected under-represented classification if multiple under-represented classifications are identified) exist to train one or more of the second set of machine-trained algorithms. In some aspects, the first set of non-machine-trained algorithms may be used (as illustrated in FIG. 13) if a number of data points/instances for an under-represented classification is not sufficient (e.g., does not meet a threshold) for training one or more of the second set of machine-trained algorithms. If the number of data points/instances (input-output data sets) is sufficient, the apparatus may bypass the first set of non-machine-trained algorithms (As shown in FIG. 13) and generate the additional input-output data sets using one or more of the second set of machine-trained algorithms.

For example, if the apparatus determines that there is not a sufficient number of input-output data sets associated with the under-represented classification to train one or more of the second set of machine-trained algorithms, the apparatus may identify a first plurality of two-dimensional images or videos for each industrial object in a set of at least one industrial objects. The set of at least one industrial object, in some aspects, may include industrial objects with a sufficient number of images to generate a 3D model. For example, referring to FIG. 5, the apparatus may identify the set of 2D raw images 505.

After identifying the first plurality of two-dimensional images or videos, the apparatus may create, based on the first plurality of two-dimensional images or videos for each of the at least one industrial objects, a three-dimensional representation of each of the at least one industrial objects at 1363. For example, referring to FIG. 5, the apparatus may use the set of 2D raw images 505 to perform 3D object creation operation 520. In some aspects, the first plurality of two-dimensional images or videos may be augmented based on a morphism or other modifications/adjustments to produce virtual objects for which a model may be created.

After creating the three-dimensional representation, the apparatus may generate, based on the three-dimensional representation of each of the at least one industrial objects, a set of two-dimensional images or videos to be included as input data sets of the additional input-output data sets. For example, referring to FIG. 5, the apparatus may use the set of 3D models produced by 3D object creation operation 520 to generate a set of additional 2D images by 2D image generation operation 535. In some aspects, the first plurality of two-dimensional images or videos may be augmented based on a morphism or other modifications/adjustments to produce virtual objects for which a model may be created. After generating the additional input-output data sets using the first set of non-machine-trained algorithms, the apparatus may return to determine if there is a sufficient number of input-output data sets associated with the under-represented classification.

If the apparatus determines that there is a sufficient number of input-output data sets associated with the under-represented classification to train one or more of the second set of machine-trained algorithms, the apparatus may proceed to train at least one of the second set of machine-trained algorithms (e.g., at least one of one of a GAN, a variational autoencoder, or a diffusion model). The training, in some aspects, may depend on the type of machine-trained algorithm being trained and may run through multiple iterations of processing input data of an input-output data set to determine an accuracy of an output of the algorithm or model at a current training step and to update the algorithm or model to improve the accuracy. The training may continue until a stopping criteria is met (e.g., a threshold number of iterations without a convergence or meeting a threshold accuracy criteria). While specific machine-trained algorithms are discussed above in relation to FIGS. 8-10, other machine-trained algorithms or models may be used in accordance with the needs of a particular application of the method in accordance with some aspects of the disclosure. For example, referring to FIG. 6, the apparatus may perform one or more of the GAN training operation 610, the variational autoencoder training operation 615, and the diffusion model training operation 620, or other training operation for a model/network to generate images in conjunction with similarity determination component 625.

Once trained, the apparatus may generate, using the (machine-trained) generative process, additional two-dimensional images or videos (associated with the under-represented classification) to be included as input data sets of the additional input-output data sets. For example, referring to FIG. 6, one or more of GAN, a variational autoencoder, or a diffusion model trained by the GAN training operation 610, the variational autoencoder training operation 615, and the diffusion model training operation 620, respectively, may be deployed by model deployment component 630 to generate additional instances using new instance generation operation 635. The additional two-dimensional images or videos generated at 1160, in some aspects, may already be associated with a classification (or label) based on a ‘parent’ input image or video (or set of images or videos) used to generate the additional two-dimensional image or video. In some aspects, the label may be generated and/or validated by one or more of the initial machine-trained model or by a SME reviewing or validating at least a subset of generated additional two-dimensional images or videos as described in relation to auto-labeling/annotation component 255 of FIG. 2.

The apparatus may then determine whether a sufficient number of additional input-output data sets have been generated. The determination, in some aspects, may be based on the determination of the minimum number of input-output data sets for each classification to produce a balanced set of training data and a current number of input-output data sets associated with the under-represented classification (based on either the second set of machine-trained algorithms or the first and second set of algorithms, non-machine-trained and machine-trained, respectively). For example, referring to FIGS. 3, 4, and 6, the new instance generation operation 635 may continue until a number of instances associated with a classification meets or exceed a minimum number of instance indicated by the threshold number 305 or the balancing computation 420. If the apparatus determines that the sufficient number of additional input-output data sets has not been generated, the apparatus may return to generate additional two-dimensional images or videos to be included as input data sets of the additional input-output data sets. The generation of additional input-output data sets may be performed for each of a plurality of classifications that are identified as being under-represented based on at least the steps or operations 1110 and 1160.

If the apparatus determines that the sufficient number of additional input-output data sets has been generated, the apparatus may proceed from automatically (or programmatically) generating, for inclusion with the initial set of training data in a modified set of training data, additional input-output data sets for the identified at least one classification to balance a representation of the classifications of the plurality of classifications in the modified set of training data at 1160 to train a machine-trained model based on the modified set of training data comprising at least a subset of the initial set of training data and the additional input-output data sets at 1170. As described in relation to the training performed by model training operation 320, the model training may use a genetic algorithm (e.g., the NES algorithm) or other training algorithm to train (or update) the machine-trained model based on the balanced data set including at least the subset of the initial set of training data (e.g., the initial training data set with or without the data associated with the over-represented ignored or removed) and the additional input-output data sets generated at 1160 (for one or more under-represented classifications). In some

After training the machine trained model at 1170, the apparatus may use the machine-trained model to generate at least one corresponding classification for at least one input data set relating to at least one industrial object to identify whether the at least one industrial object is associated with a failure event or a non-failure event. The at least one industrial object, in some aspects, may be unlabeled/unclassified (e.g., may be newly collected data) associated with an industrial defect and/or failure-detection operation or may be from a set of test data.

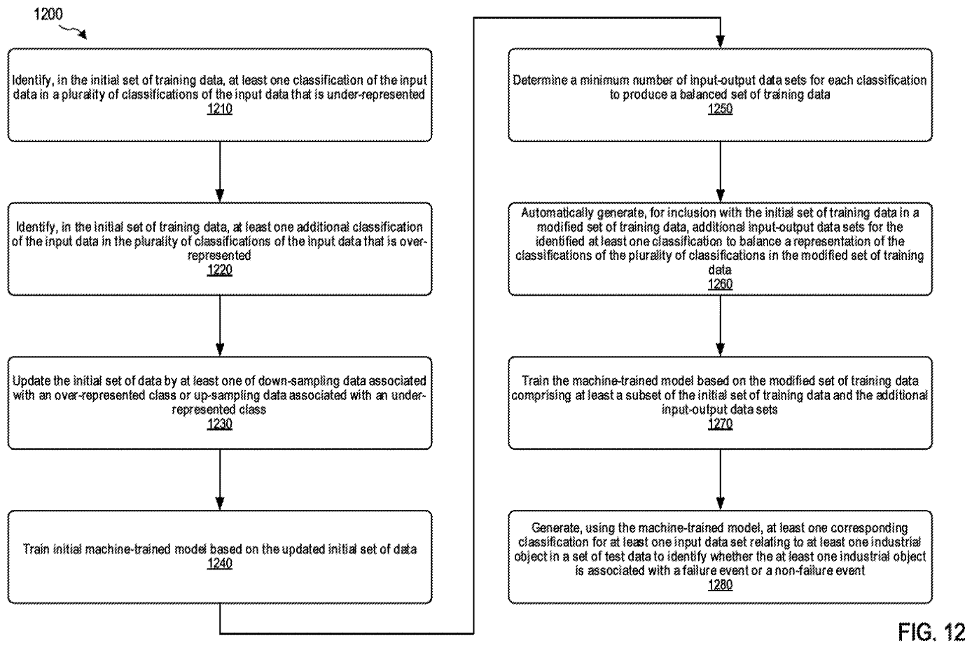

FIG. 12 is a flow diagram 1200 illustrating a method in accordance with some aspects of the disclosure. In some aspects, the method is performed by an inference engine or analysis apparatus (e.g., the system of diagram 100 or computer device 1405) that performs various analyses, machine-training operations, data augmentation operations, and inference (e.g., classification) operations based on collected data relating to industrial processes and/or components. The method may be for an industrial failure detection based on an initial set of training data. The initial set of training data may include a plurality of input-output data sets each comprising input data regarding an industrial object and output data regarding at least one classification of the input data. At 1210, the apparatus may identify, in an initial set of training data, at least one classification of the input data in a plurality of classifications of the input data that is under-represented. For example, referring to FIGS. 1 and 3, 1210 may be performed by the distributed model training component 104 or the dataset analysis and preparation operation 310 as discussed in relation to FIGS. 1-6. In some aspects, the input data may include at least one of image data, video data, audio data, x-ray data, MRI data, PET-scan data, infrared image data, UV image data, thermal data, or any other type of industrial data susceptible to analysis by machine-trained networks for classification.

At 1220, the apparatus may identify, in the initial set of training data, at least one additional classification of the input data in the plurality of classifications of the input data that is over-represented. In some aspects, the identification of the under-represented and under-represented classifications is based on a target distribution of data points (or instances, such as images or other data) among a plurality of classifications to produce an accurate machine-trained models. The target distribution, in some aspects, may indicate a range of acceptable distributions (fractions or percentages) for each classification in a plurality of classifications that may be converted into a number of data points based on a total number of data points in an initial (e.g., unbalanced) dataset for machine-learning-based model training. For example, referring to FIGS. 1 and 3, 1210 may be performed by the distributed model training component 104 or the dataset analysis and preparation operation 310 as discussed in relation to FIGS. 1-6.

Based on the identification of the under-represented classification at 1210 and the over-represented classification at 1220, the apparatus may, at 1230, update the initial data set by at least one of down-sampling data associated with the over-represented class or up-sampling data associated with the under-represented class. The down-sampling, in some aspects, may include removing (or ignoring) a first number of input-output data sets from the initial set of training data for training a machine-trained model. The up-sampling, in some aspects, may include duplicating data points associated with the under-represented classification to ensure there are enough examples of the under-represented classification to affect the configuration of the machine-trained model (e.g., a set of weights associated with the machine-trained model). For example, referring to FIGS. 1 and 3, 1230 may be performed by the distributed model training component 104 or the dataset analysis and preparation operation 310 as discussed in relation to FIGS. 1-6.

The apparatus, at 1240, to train an initial machine-trained model based on the updated initial set of data produced at 1230. The initial training of the machine-trained model, in some aspects, may be based on a genetic algorithm as discussed in relation to FIG. 2. The initial training of the machine-trained model may be validated using a subset of the initial set of training data not used for training the machine-trained model (e.g., an associated set of validation data that is derived from a larger common data set that is sub-divided into the set of training data and the associated set of validation and/or test data). The validation, in some aspects, may be used to determine when to terminate a training operation and deploy the machine-trained model. For example, referring to FIGS. 1 and 3, 1240 may be performed by the distributed model training component 104 or the model training operation 320 as discussed in relation to FIGS. 1-6.

At 1250, the apparatus may determine a minimum number of input-output data sets for each classification to produce a balanced set of training data. In some aspects, the determination at 1250 may be based on the analysis performed at one or more of 1210 and/or 1220. The minimum number of input-output data sets for a particular classification may be based on a desired (or known) ratio, fraction, and/or percentage associated with different classifications for generating (or training) an accurate model, and a total number of data points (e.g., input-output data sets or instances). For example, referring to FIGS. 1 and 3, 1250 may be performed by the distributed model training component 104 or the model precision calculation operation 315 to produce the threshold number 305 as discussed in relation to FIGS. 1-6.

At 1260, the apparatus may automatically (or programmatically) generate, for inclusion with the initial set of training data in a modified set of training data, additional input-output data sets for the identified at least one classification to balance a representation of the classifications of the plurality of classifications in the modified set of training data. FIG. 13 illustrates a method of automatically, or programmatically, generating additional input-output data sets in accordance with some aspects of the disclosure. Referring to FIGS. 1 and 4-6, 1260 and the method of FIG. 13, in some aspects, may be performed by one or more of data analysis component 103, image generation component 105, generative model training component 106, tensor framework image generation component 107, elements 505-535 of FIG. 5, elements 605-635 of FIG. 6, or in association with determination 405. The generation of the additional input-output data sets, in some aspects, may include one or more different types of image generation algorithms. For example, a first set of non-machine-trained algorithms, e.g., a morphism-based algorithm or a 3D model generation-based algorithm as described in relation to elements 505 to 535 of FIG. 5, or a second set of machine-trained algorithms as described in relation to elements 605 to 635 of FIG. 6.

As part of generating the additional input-output sets at 1260, the apparatus may, at 1361, determine whether a sufficient number of input-output data sets associated with the under-represented classification (a currently selected under-represented classification if multiple under-represented classifications are identified) exist to train one or more of the second set of machine-trained algorithms. In some aspects, the first set of non-machine-trained algorithms may be used (as illustrated in FIG. 13) if a number of data points/instances for an under-represented classification is not sufficient (e.g., does not meet a threshold) for training one or more of the second set of machine-trained algorithms. If the number of data points/instances (input-output data sets) is sufficient, the apparatus may bypass the first set of non-machine-trained algorithms (As shown in FIG. 13) and generate the additional input-output data sets using one or more of the second set of machine-trained algorithms.

For example, if the apparatus determines at 1361 that there is not a sufficient number of input-output data sets associated with the under-represented classification to train one or more of the second set of machine-trained algorithms, the apparatus may identify a first plurality of two-dimensional images or videos for each industrial object in a set of at least one industrial objects at 1362. The set of at least one industrial object, in some aspects, may include industrial objects with a sufficient number of images to generate a 3D model. For example, referring to FIG. 5, the apparatus may identify the set of 2D raw images 505.

After identifying the first plurality of two-dimensional images or videos at 1362, the apparatus may create, based on the first plurality of two-dimensional images or videos for each of the at least one industrial objects, a three-dimensional representation of each of the at least one industrial objects at 1363. For example, referring to FIG. 5, the apparatus may use the set of 2D raw images 505 to perform 3D object creation operation 520 corresponding to 1363. In some aspects, the first plurality of two-dimensional images or videos may be augmented based on a morphism or other modifications/adjustments to produce virtual objects for which a model may be created at 1363.

After creating the three-dimensional representation at 1363, the apparatus may generate, based on the three-dimensional representation of each of the at least one industrial objects, a set of two-dimensional images or videos to be included as input data sets of the additional input-output data sets at 1364. For example, referring to FIG. 5, the apparatus may use the set of 3D models produced by 3D object creation operation 520 to generate a set of additional 2D images by 2D image generation operation 535 corresponding to 1364. In some aspects, the first plurality of two-dimensional images or videos may be augmented based on a morphism or other modifications/adjustments to produce virtual objects for which a model may be created at 1363. After generating the additional input-output data sets using the first set of non-machine-trained algorithms, the apparatus may return to determine, at 1361, if there is a sufficient number of input-output data sets associated with the under-represented classification.

If the apparatus determines, at 1361, that there is a sufficient number of input-output data sets associated with the under-represented classification to train one or more of the second set of machine-trained algorithms, the apparatus may proceed to train at least one of the second set of machine-trained algorithms (e.g., at least one of one of a GAN, a variational autoencoder, or a diffusion model) at 1365. The training at 1365, in some aspects, may depend on the type of machine-trained algorithm being trained and may run through multiple iterations of processing input data of an input-output data set to determine an accuracy of an output of the algorithm or model at a current training step and to update the algorithm or model to improve the accuracy. The training may continue until a stopping criteria is met (e.g., a threshold number of iterations without a convergence or meeting a threshold accuracy criteria). While specific machine-trained algorithms are discussed above in relation to FIGS. 8-10, other machine-trained algorithms or models may be used in accordance with the needs of a particular application of the method in accordance with some aspects of the disclosure. For example, referring to FIG. 6, the apparatus may perform one or more of the GAN training operation 610, the variational autoencoder training operation 615, and the diffusion model training operation 620, or other training operation for a model/network to generate images in conjunction with similarity determination component 625 corresponding to training at least one of the second set of machine-trained algorithms at 1365.

Once trained at 1365, the apparatus may generate, using the (machine-trained) generative process, additional two-dimensional images or videos (associated with the under-represented classification) to be included as input data sets of the additional input-output data sets at 1366. For example, referring to FIG. 6, one or more of GAN, a variational autoencoder, or a diffusion model trained by the GAN training operation 610, the variational autoencoder training operation 615, and the diffusion model training operation 620, respectively, may be deployed by model deployment component 630 to generate additional instances using new instance generation operation 635 corresponding to 1366. The additional two-dimensional images or videos generated at 1260 and/or 1366, in some aspects, may already be associated with a classification (or label) based on a ‘parent’ input image or video (or set of images or videos) used to generate the additional two-dimensional image or video. In some aspects, the label may be generated and/or validated by one or more of the initial machine-trained model trained at 1240 or by a SME reviewing or validating at least a subset of generated additional two-dimensional images or videos as described in relation to auto-labeling/annotation component 255 of FIG. 2.

The apparatus may then determine, at 1367, whether a sufficient number of additional input-output data sets have been generated. The determination, in some aspects, may be based on the determination, at 1250, of the minimum number of input-output data sets for each classification to produce a balanced set of training data and a current number of input-output data sets associated with the under-represented classification (based on either the second set of machine-trained algorithms or the first and second set of algorithms, non-machine-trained and machine-trained, respectively). For example, referring to FIGS. 3, 4, and 6, the new instance generation operation 635 may continue until a number of instances associated with a classification meets or exceed a minimum number of instance indicated by the threshold number 305 or the balancing computation 420. If the apparatus determines, at 1367, that the sufficient number of additional input-output data sets has not been generated, the apparatus may return to 1366 to generate additional two-dimensional images or videos to be included as input data sets of the additional input-output data sets. The generation of additional input-output data sets may be performed for each of a plurality of classifications that are identified as being under-represented based on at least the steps or operations 1210, 1250, and 1260.

If the apparatus determines, at 1367, that the sufficient number of additional input-output data sets has been generated, the apparatus may end the method of FIG. 13 and proceed from automatically (or programmatically) generating, for inclusion with the initial set of training data in a modified set of training data, additional input-output data sets for the identified at least one classification to balance a representation of the classifications of the plurality of classifications in the modified set of training data at 1260 to train a machine-trained model based on the modified set of training data comprising at least a subset of the initial set of training data and the additional input-output data sets at 1270. As described in relation to the training performed by model training operation 320, the model training may use a genetic algorithm (e.g., the NES algorithm) or other training algorithm to train (or update) the machine-trained model based on the balanced data set including at least the subset of the initial set of training data (e.g., the initial training data set with or without the data associated with the over-represented ignored or removed) and the additional input-output data sets generated at 1260 (for one or more under-represented classifications). In some

After training the machine trained model at 1270, the apparatus may use the machine-trained model, at 1280, to generate at least one corresponding classification for at least one input data set relating to at least one industrial object to identify whether the at least one industrial object is associated with a failure event or a non-failure event. The at least one industrial object, in some aspects, may be unlabeled/unclassified (e.g., may be newly collected data) associated with an industrial defect and/or failure-detection operation or may be from a set of test data.

The disclosed method, apparatus, and system, in some aspects, may improve the training of machine-trained networks in the presence of unbalanced data sets in which under-represented classes (e.g., labels or classifications) may be effectively ignored in favor of an over-represented class. For example, a data set that includes a percentage of inputs associated with a first classification (e.g., 99% of the images may be associated with a normal classification) that is above an accuracy threshold (e.g., an accuracy threshold of 95%) used to terminate a training operation may be trained to recognize only the first classification as the machine-trained model or algorithm trained to accurately identify (label or classify) only the normal state (e.g., with a 95.2% accuracy) would meet the accuracy threshold even if all other classifications were mislabeled 100% of the time, or if the machine-trained model or algorithm labeled everything as normal, it would achieve 99% accuracy. Accordingly, generating additional data to balance an unbalanced data set provides an improvement to machine-training of networks for identifying rare events/classifications.

Additionally, the method, apparatus, and system, in some aspects, may provide benefits relating to being able to train an accurate model with limited collected data. The auto-labeling, in some aspects, may also conserve resources by reducing the need for involving human SMEs that may be costly and significantly slower than the algorithmic labeling. The improved models may also provide the benefits of being able to accurately identify defects or failure-events associated with industrial equipment that may lead to large losses for a company in the form of downtime of, more significantly, catastrophic failure events such as a downed power line leading to a forest fire or other damage to nearby people or property. Additionally, the method, apparatus, and system, in some aspects, may be applied to any type of data using the appropriate machine-trained networks for data generation and/or analysis/inference.

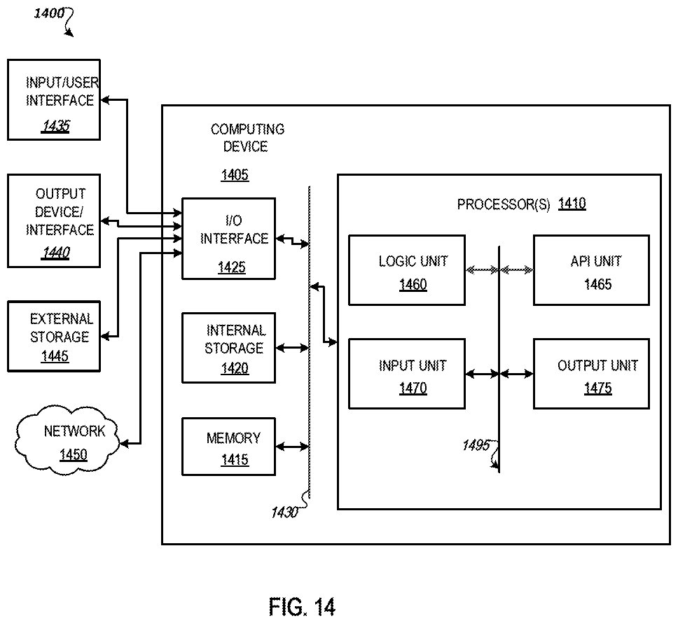

FIG. 14 illustrates an example computing environment with an example computer device suitable for use in some example implementations. Computer device 1405 in computing environment 1400 can include one or more processing units, cores, or processors 1410, memory 1415 (e.g., RAM, ROM, and/or the like), internal storage 1420 (e.g., magnetic, optical, solid-state storage, and/or organic), and/or IO interface 1425, any of which can be coupled on a communication mechanism or bus 1430 for communicating information or embedded in the computer device 1405. IO interface 1425 is also configured to receive images from cameras or provide images to projectors or displays, depending on the desired implementation.

Computer device 1405 can be communicatively coupled to input/user interface 1435 and output device/interface 1440. Either one or both of the input/user interface 1435 and output device/interface 1440 can be a wired or wireless interface and can be detachable. Input/user interface 1435 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1440 may include a display, television, monitor, printer, speaker, braille, or the like. In some example implementations, input/user interface 1435 and output device/interface 1440 can be embedded with or physically coupled to the computer device 1405. In other example implementations, other computer devices may function as or provide the functions of input/user interface 1435 and output device/interface 1440 for a computer device 1405.

Examples of computer device 1405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1405 can be communicatively coupled (e.g., via IO interface 1425) to external storage 1445 and network 1450 for communicating with any number of networked components, devices, and systems, including one or more computer devices of the same or different configuration. Computer device 1405 or any connected computer device can be functioning as, providing services of, or referred to as a server, client, thin server, general machine, special-purpose machine, or another label.

IO interface 1425 can include but is not limited to, wired and/or wireless interfaces using any communication or IO protocols or standards (e.g., Ethernet, 1402.11x, Universal System Bus, WiMax, modem, a cellular network protocol, and the like) for communicating information to and/or from at least all the connected components, devices, and network in computing environment 1400. Network 1450 can be any network or combination of networks (e.g., the Internet, local area network, wide area network, a telephonic network, a cellular network, satellite network, and the like).

Computer device 1405 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1410 can execute under any operating system (OS) (not shown), in a native or virtual environment. One or more applications can be deployed that include logic unit 1460, application programming interface (API) unit 1465, input unit 1470, output unit 1475, and inter-unit communication mechanism 1495 for the different units to communicate with each other, with the OS, and with other applications (not shown). The described units and elements can be varied in design, function, configuration, or implementation and are not limited to the descriptions provided. Processor(s) 1410 can be in the form of hardware processors such as central processing units (CPUs) or in a combination of hardware and software units.

In some example implementations, when information or an execution instruction is received by API unit 1465, it may be communicated to one or more other units (e.g., logic unit 1460, input unit 1470, output unit 1475). In some instances, logic unit 1460 may be configured to control the information flow among the units and direct the services provided by API unit 1465, the input unit 1470, the output unit 1475, in some example implementations described above. For example, the flow of one or more processes or implementations may be controlled by logic unit 1460 alone or in conjunction with API unit 1465. The input unit 1470 may be configured to obtain input for the calculations described in the example implementations, and the output unit 1475 may be configured to provide an output based on the calculations described in example implementations.

Processor(s) 1410 can be configured to identify, in the initial set of training data, at least one classification of the input data in a plurality of classifications of the input data that is under-represented. The processor(s) 1410 can be configured to automatically generate, for inclusion with the initial set of training data in a modified set of training data, additional input-output data sets for the identified at least one classification to balance a representation of the classifications of the plurality of classifications in the modified set of training data. The processor(s) 1410 can be configured to train the machine-trained model based on the modified set of training data comprising at least a subset of the initial set of training data and the additional input-output data sets. The processor(s) 1410 can be configured to use the machine-trained model to generate at least one corresponding classification for at least one input data set relating to at least one industrial object in a set of test data to identify whether the at least one industrial object is associated with a failure event or a non-failure event. The processor(s) 1410 can be configured to identify a first plurality of two-dimensional images or videos for each of the at least one industrial objects. The processor(s) 1410 can be configured to create, based on the first plurality of two-dimensional images or videos for each of the at least one industrial objects, a three-dimensional representation of each of the at least one industrial objects. The processor(s) 1410 can be configured to generate, based on the three-dimensional representation of each of the at least one industrial objects, the set of two-dimensional images or videos comprised in the input data of the additional input-output data sets. The processor(s) 1410 can be configured to determine a minimum number of input-output data sets for each classification to produce a balanced set of training data. The processor(s) 1410 can be configured to identify, in the initial set of training data, at least one additional classification of the input data in the plurality of classifications of the input data that is over-represented. The processor(s) 1410 can be configured to remove a first number of input-output data sets from the initial set of training data, wherein the subset of the initial set of training data comprises the initial set of training data after removing the first number of input-output data sets.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying.” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for training a machine-trained model for industrial failure detection based on an initial set of training data comprising a plurality of input-output data sets each comprising input data regarding an industrial object and output data regarding at least one classification of the input data, the method comprising:
identifying, in the initial set of training data, at least one classification of the input data in a plurality of classifications of the input data that is under-represented;
automatically generating, for inclusion with the initial set of training data in a modified set of training data, additional input-output data sets for the identified at least one classification to balance a representation of the at least one classification of the plurality of classifications in the modified set of training data; and
training the machine-trained model based on the modified set of training data comprising at least a subset of the initial set of training data and the additional input-output data sets.

2. The method of claim 1, further comprising:
using the machine-trained model to generate at least one corresponding classification for at least one input data set relating to at least one industrial object in a set of test data to identify whether the at least one industrial object is associated with a failure event or a non-failure event.

3. The method of claim 1, wherein the input data of the additional input-output data sets comprises a set of two-dimensional images or videos associated with at least one industrial object, and the automatically generating the additional input-output data sets comprises:
identifying a first plurality of two-dimensional images or videos for each of the at least one industrial object;
creating, based on the first plurality of two-dimensional images or videos for each of the at least one industrial object, at least one three-dimensional representation corresponding to the at least one industrial object; and
generating, based on the three-dimensional representation of each of the at least one industrial object, the set of two-dimensional images or videos comprised in the input data of the additional input-output data sets.

4. The method of claim 3, wherein the set of two-dimensional images comprised in the input data of the additional input-output data sets comprises a second plurality of two-dimensional images associated with the at least one three-dimensional representation, wherein generating the second plurality of two-dimensional images comprises varying a set of parameters used to generate each two-dimensional image of the second plurality of two-dimensional images, wherein the set of parameters comprise at least one of a position relative to the at least one three-dimensional representation associated with the two-dimensional image, a brightness associated with the two-dimensional image, a lightness associated with the two-dimensional image, a saturation associated with the two-dimensional image, or a focus associated with the two-dimensional image.

5. The method of claim 1, wherein the automatically generating is based on a morphism associated with at least one input data associated with the at least one classification.

6. The method of claim 5, wherein the morphism is associated with at least one of a first autoencoder associated with a first industrial object type associated with the at least one input data and a second autoencoder associated with a second industrial object type, wherein at least one additional input-output data set of the additional input-output data sets for the identified at least one classification comprises an input data set associated with the second industrial object type based on the at least one input data, wherein the first industrial object type comprises a particular industrial object made from a first material and the second industrial object type comprises the particular industrial object made from a second material.

7. The method of claim 1, wherein the automatically generating is performed using at least one of a generative adversarial network, a variational encoder, or a diffusion model.

8. The method of claim 1, wherein the input data comprises at least one of image data, video data, audio data, x-ray data, magnetic resonance imaging (MRI) data, positron emission tomography (PET) scan data, infrared image data, or thermal data.

9. The method of claim 1, further comprising:
determining a minimum number of input-output data sets for each classification to produce a balanced set of training data, wherein identifying the at least one classification of the input data that is under-represented comprises determining that the at least one classification is associated with a first number of input-output data sets in the initial set of training data that is below the minimum number of input-output data sets, and wherein the automatically generating the additional input-output data sets for the identified at least one classification comprises automatically generating a second number of additional input-output data sets that when added to the first number is greater than the minimum number.

10. The method of claim 1, further comprising:
identifying, in the initial set of training data, at least one additional classification of the input data in the plurality of classifications of the input data that is over-represented; and
removing a first number of input-output data sets from the initial set of training data, wherein the subset of the initial set of training data comprises the initial set of training data after removing the first number of input-output data sets.

11. An apparatus for training a machine-trained model for industrial failure detection based on an initial set of training data comprising a plurality of input-output data sets each comprising input data regarding an industrial object and output data regarding at least one classification of the input data, comprising:
a memory; and
at least one processor coupled to the memory and, based at least in part on information stored in the memory, the at least one processor is configured to:
identify, in the initial set of training data, at least one classification of the input data in a plurality of classifications of the input data that is under-represented;
automatically generate, for inclusion with the initial set of training data in a modified set of training data, additional input-output data sets for the identified at least one classification to balance a representation of the classifications of the plurality of classifications in the modified set of training data; and
train the machine-trained model based on the modified set of training data comprising at least a subset of the initial set of training data and the additional input-output data sets.

12. The apparatus of claim 11, wherein the at least one processor is further configured to:
use the machine-trained model to generate at least one corresponding classification for at least one input data set relating to at least one industrial object in a set of test data to identify whether the at least one industrial object is associated with a failure event or a non-failure event.

13. The apparatus of claim 11, wherein the input data of the additional input-output data sets comprises a set of two-dimensional images or videos associated with at least one industrial object, and the at least one processor configured to automatically generate the additional input-output data sets is configured to:
identify a first plurality of two-dimensional images or videos for each of the at least one industrial object;
create, based on the first plurality of two-dimensional images or videos for each of the at least one industrial object, at least one three-dimensional representation corresponding to the at least one industrial object; and
generate, based on the three-dimensional representation of each of the at least one industrial object, the set of two-dimensional images or videos comprised in the input data of the additional input-output data sets.

14. The apparatus of claim 13, wherein the set of two-dimensional images comprised in the input data of the additional input-output data sets comprises a second plurality of two-dimensional images associated with the at least one three-dimensional representation, wherein the at least one processor configured to generate the second plurality of two-dimensional images is configured to vary a set of parameters used to generate each two-dimensional image of the second plurality of two-dimensional images, wherein the set of parameters comprise at least one of a position relative to the at least one three-dimensional representation associated with the two-dimensional image, a brightness associated with the two-dimensional image, a lightness associated with the two-dimensional image, a saturation associated with the two-dimensional image, or a focus associated with the two-dimensional image.

15. The apparatus of claim 11, wherein the at least one processor configured to automatically generate additional input-output data sets using a morphism associated with at least one input data associated with the at least one classification.

16. The apparatus of claim 15, wherein the morphism is associated with at least one of a first autoencoder associated with a first industrial object type associated with the at least one input data and a second autoencoder associated with a second industrial object type, wherein at least one additional input-output data set of the additional input-output data sets for the identified at least one classification comprises an input data set associated with the second industrial object type based on the at least one input data, wherein the first industrial object type comprises a particular industrial object made from a first material and the second industrial object type comprises the particular industrial object made from a second material.

17. The apparatus of claim 11, wherein the at least one processor configured to automatically generate additional input-output data sets using at least one of a generative adversarial network, a variational encoder, or a diffusion model.

18. The apparatus of claim 11, wherein the input data comprises at least one of image data, video data, audio data, x-ray data, magnetic resonance imaging (MRI) data, positron emission tomography (PET) scan data, infrared image data, or thermal data.

19. The apparatus of claim 11, wherein the at least one processor is further configured to:
determine a minimum number of input-output data sets for each classification to produce a balanced set of training data, wherein the at least one processor configured to identify the at least one classification of the input data that is under-represented is configured to determine that the at least one classification is associated with a first number of input-output data sets in the initial set of training data that is below the minimum number of input-output data sets, and wherein the at least one processor configured to automatically generate the additional input-output data sets for the identified at least one classification is configured to automatically generate a second number of additional input-output data sets that when added to the first number is greater than the minimum number.

20. The apparatus of claim 11, wherein the at least one processor is further configured to:
identify, in the initial set of training data, at least one additional classification of the input data in the plurality of classifications of the input data that is over-represented; and
remove a first number of input-output data sets from the initial set of training data, wherein the subset of the initial set of training data comprises the initial set of training data after removing the first number of input-output data sets.
